(19) United States
(12) Patent Application Publication
(10) Pub. No.: US 2020/0267900 A1
(43) Pub. Date: Aug. 27, 2020

(54) METHODS AND SYSTEMS FOR CONVEYING AND TREATING A HARVESTED MICROCROP

(71) Applicant: PARABEL NUTRITION, INC., Vero Beach, FL (US)

(72) Inventor: Matthew Van Ert, Vero Beach, FL (US)

(21) Appl. No.: 16/803,792

(22) Filed: Feb. 27, 2020

Related U.S. Application Data
(60) Provisional application No. 62/811,465, filed on Feb. 27, 2019.

(51) Int. Cl. A01D 44/00; A01G 33/00; A01D 57/00; A01G 9/14

(52) U.S. Cl. CPC A01D 44/00; A01G 33/00; A01G 2009/1461; A01G 9/1438; A01G 2009/1492; A01D 57/00

(57) ABSTRACT

The present disclosure relates, according to some embodiments, to a method of continuously supplying a harvested biomass comprising a floating aquatic plant species to a processing facility. The method includes cultivating a microcrop (e.g., a floating aquatic plant species) in a bioreactor system, harvesting the microcrop to generate the harvested biomass, and conveying the harvested biomass to a first position of a harvest canal to form a conveyed biomass. A harvest canal may include a trough configured to contain the conveyed biomass in a volume of a medium and a propulsion mechanism configured to impart a motion on the first medium such that the harvested biomass may be transported from the first position to the second position within the harvest canal. The harvest canal may be positioned adjacent to an outer perimeter of bioreactor system and form an infinity loop. The method may further include activating the propulsion mechanism to impart motion on the first medium and propel the harvested biomass from the first position to the second position, and transferring at least a portion of the propelled biomass from the second position of the harvest canal to a processing facility.

### CROSS-REFERENCE TO RELATED APPLICATIONS

This application claims priority under 35 U.S.C. § 119(e) to U.S. Provisional Application No. 62/811,465, filed on Feb. 27, 2019, which is hereby incorporated by reference in its entirety.

### FIELD OF THE DISCLOSURE

The present disclosure relates, in some embodiments, to methods and systems to convey harvested aquatic biomass and conserve crop qualities (e.g., protein content). The present disclosure further relates to methods and systems for continuously cultivating, transporting, and processing a microcrop to form a continuous stream of a microcrop product.

### BACKGROUND OF THE DISCLOSURE

A significant challenge in the commercial production of floating aquatic plant species (e.g., Lemna, Spirodela, Landoltia, Wolfiella, Salvinia, Wolffia, etc.) is the post-harvest transportation of the aquatic crop to a centralized facility (e.g., processing and/or packaging facility). These challenges are largely associated with the logistics and costs associated with transporting a high moisture content aquatic crop (e.g., >90% water). Such problems can be exacerbated by large transport distances and considerable biomass volumes inherent in large agricultural and hydroponic operations. Further, preserving the integrity and quality of aquatic crops and high moisture content crops during transportation in ambient field temperatures is a great concern, as a harvested biomass can quickly undergo changes that diminish aquatic crop quality (e.g., organoleptic properties, protein content and/or protein quality).

The present disclosure relates to methods and systems to convey harvested aquatic biomass and conserve crop integrity (e.g., protein content, protein quality). The methods and systems disclosed herein may be utilized in harvesting a floating aquatic plant species (e.g., a microcrop), conserving a crop protein content, and treating a harvested biomass to enhance desirable properties. References herein to a floating aquatic plant species, an aquatic microcrop, a microcrop, or a biomass (e.g., a harvested microcrop), may encompass both a single photosynthetic floating aquatic plant species and combinations of multiple photosynthetic floating aquatic plant species.

### SUMMARY

The present disclosure relates, according to some embodiments, to harvest canals for conveying a harvested biomass including a floating aquatic plant. A harvest canal includes a trough, a canopy, and a propulsion mechanism. A trough can have at least two peripheral walls that are joined to generate a bottom surface and an open top surface. A trough may be configured to contain the harvested biomass in a volume of a first medium. A canopy can be secured over the open top surface of the trough so that it generates a shaded interior upon exposure to a light source. A canopy may comprise a woven material comprising one or more of a polyester, a polyethylene, an aramid, an acrylic, a nylon, a polyurethane, a spandex, an olefin, a lurex, a carbon fiber, a grass, a straw, a cotton, a rayon, a silk, and a wool. In some embodiments, a canopy may include at least one of a light inhibitor (e.g., UV inhibitor) and a thermal stabilizer. In some embodiments, the canopy may shade the interior at least 60% compared to an external surface of the canopy. The propulsion mechanism is configured to impart a motion on the first medium such that the harvested aquatic biomass is transported from a first position of the harvest canal system to a second position of the harvest canal system.

In some embodiments, a disclosed harvest canal system may include a propulsion mechanism, such as a paddle wheel, a bubbler, a submerged water jet, and a surface water jet. A propulsion mechanism may be configured to impart a velocity on the first medium in a range from about 0.1 m/s to about 0.20 m/s.

According to some embodiments, a harvest canal system may further include a nutrient delivery system; a monitor configured to measure at least one of a nutrient composition, a gas composition, and a temperature of the first medium; a monitor configured to measure a velocity of the first medium; a monitor configured to measure a thickness of a mat of the harvested biomass; a monitor configured to measure a percentage of the harvested biomass that is submerged; or any combination thereof.

The present disclosure further relates to methods for conveying a harvested biomass comprising a floating aquatic plant species from a harvest apparatus to a second location. A method may include conveying the harvested biomass to a first position of a harvest canal having a trough, a canopy, and a propulsion mechanism. A propulsion mechanism may be configured to impart a motion on a first medium within the harvest canal such that the harvested biomass is transported from the first position to the second position. And the method may further include activating the propulsion mechanism to impart such motion.

The present disclosure further relates to methods of continuously supplying a harvested biomass comprising a floating aquatic plant species to a processing facility. The method includes cultivating a microcrop (e.g., a floating aquatic plant species) in a bioreactor system, harvesting the microcrop to generate the harvested biomass, and conveying the harvested biomass to a first position of a harvest canal to form a conveyed biomass. A harvest canal may include a trough configured to contain the conveyed biomass in a volume of a medium and a propulsion mechanism configured to impart a motion on the first medium such that the harvested biomass may be transported from the first position to the second position within the harvest canal. The harvest canal may be positioned adjacent to an outer perimeter of bioreactor system and form an infinity loop. The method may further include activating the propulsion mechanism to impart motion on the first medium and propel the harvested biomass from the first position to the second position, and transferring at least a portion of the propelled biomass from the second position of the harvest canal to a processing facility.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

Some embodiments of the disclosure may be understood by referring, in part, to the present disclosure and the accompanying drawings, wherein:

FIG. 1 is a flow diagram illustrating a method for conveying and treating a biomass according to a specific embodiment of the disclosure.

FIG. 2 is a system diagram illustrating a system for conveying harvested aquatic biomass according to a specific embodiment of the disclosure;

FIG. 3A is a cross-section of a harvest canal having two peripheral walls connected by a bottom where the harvest canal is covered by a canopy having supports;

FIG. 3B is a cross-section of a harvest canal having two intersecting peripheral walls that each have a support and where the harvest canal is covered by a canopy that directly interacts with the harvest canal;

FIG. 3C is a cross-section of a harvest canal having a curved shape where the harvest canal is covered by a canopy having multiple supports; and

FIG. 3D is a canopy, a support for the canopy, a cross-section of a harvest canal having two peripheral walls connected by a bottom and where the harvest canal is covered by a canopy that directly contacts the harvest canal; and

FIG. 3E is an isometric view of a harvest canal covered by a canopy having two supports.

### DETAILED DESCRIPTION

The present disclosure relates to methods and systems for conveying a harvested microcrop (i.e., a biomass) (e.g., harvested Lemna) to a processing facility such that a microcrop product can be derived therefrom. According to some embodiments, a microcrop product may have improved crop integrity (e.g., protein content, protein quality).

In some embodiments, a microcrop may comprise a single floating aquatic plant species (e.g., Lemna species, Salvinia species). A microcrop may include species of Lemna (e.g., duckweed), Spirodela, Landoltia, Wolfiella, Salvinia (e.g., floating fern), Wolffia (e.g., watermeal), Azolla (e.g., mosquito fern), Pistia (e.g., water lettuce), or any combination thereof. According to some embodiments, a microcrop may be a species of Lemna, for example, Lemna minor, Lemna obscura, Lemna minuta, Lemna gibba, Lemna valdiviana, or Lemna aequinoctialis. A microcrop may comprise, according to some embodiments, a combination of two or more floating aquatic plant species. In some embodiments, a microcrop may be selected from a local floating aquatic plant species based on identified compositional and growth characteristics that have developed within the local environmental conditions. Local species may out-compete other species in open ponds or bioreactors based on their adaptation to the local environmental conditions. A microcrop, in some embodiments, may be adjusted in response to seasonal variations in temperature and light availability.

A microcrop may have characteristics that are advantageous in comparison to other aquatic species (e.g., rapid growth rate; reduced nutritional requirements; ease of harvesting and/or processing; enhanced amino acid profile; enhanced palatability; reduced evapotranspiration rate; increased protein composition).

For example, Lemna is a genus of free-floating aquatic plants from the Lemnaceae family (e.g., duckweed) that grow rapidly. Lemna protein has an essential amino acid profile that more closely resembles animal protein than most other plant proteins. Table 1 shows a typical essential amino acid compositional profile of Lemna protein. Additionally, Lemna provides high protein yields, with freshly harvested Lemna containing up to about 43% protein by dry weight.

TABLE 1
Essential Amino Acid Profile of Lemna Protein

| Essential Amino Acid | Protein (g/100 g) |
|---|---|
| Lysine | 5.9 |
| Leucine | 9.7 |
| Isoleucine | 5.1 |
| Methionine | 2.4 |
| Phenylalanine | 6.3 |
| Threonine | 4.4 |
| Tryptophan | 2.0 |
| Valine | 6.3 |
| Histidine | 2.7 |
| Arginine | 6.8 |

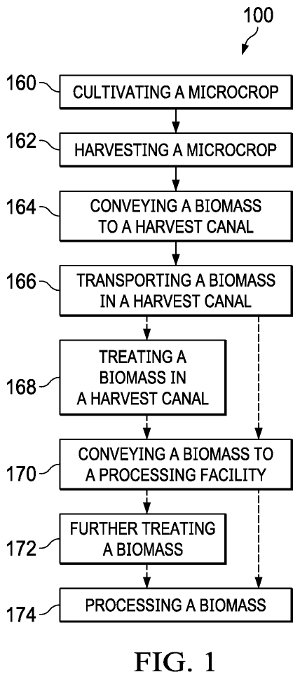

As illustrated in FIG. 1, a method to convey a harvested microcrop 100 may include cultivating a microcrop 160, harvesting a microcrop 162 to generate a biomass, conveying a biomass to a harvest canal 164, transporting a biomass in a harvest canal 166, conveying a biomass to a processing facility 170, and processing a biomass 174 to generate a microcrop product. According to some embodiments, the method 100 may further comprise one or more of treating a biomass in a harvest canal 168 and further treating a biomass 172 at a processing facility.

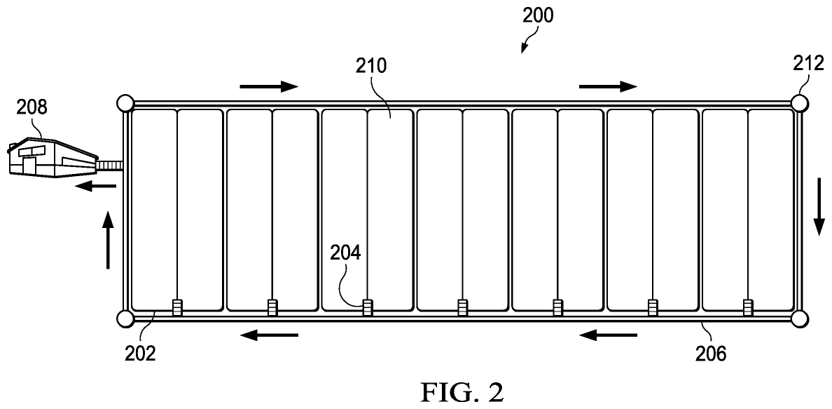

FIG. 2 illustrates a system 200 including an aquatic crop farm 202, one or more biomass transfer apparatuses 204, a harvest canal 206, and a processing center 208. An aquatic crop farm 202 may comprise one or more bioreactors 210 (e.g., aquatic growth areas). According to some embodiments, a harvest canal 206 may comprise a trough, a canopy, and one or more propulsion mechanisms 212.

### Cultivation of a Microcrop

In some embodiments a microcrop (e.g., Lemna) may be asexually propagated (e.g., cultivated) by contacting the microcrop with a growth medium (e.g., an aqueous nutrient composition) under conditions that permit expansion. A microcrop may be cultivated in a bioreactor system comprised in an aquatic crop farm (e.g., growth area), according to some embodiments. A bioreactor system may contain a growth medium comprising water and/or a nutrient composition, according to some embodiments. A nutrient composition, in some embodiments, may include at least one of nitrogen, phosphorus, potassium, and calcium. In some embodiments, a growth medium may comprise dissolved gaseous oxygen and/or dissolved gaseous carbon dioxide.

A growth medium (e.g., an aqueous nutrient composition) may be provided in and/or added to a bioreactor (e.g., a pond) and may be maintained at a desired set-point level (e.g., specific volume), according to some embodiments. A bioreactor system, in some embodiments, may be configured to collect rainfall and/or to intake water from a source of ground, surface, or recycled water (e.g., storm water, recycled water) or any other suitable water source. According to some embodiments, a bioreactor system may further comprise an additional storage container (e.g., container or pond) for excess growth medium.

In some embodiments, one or more smaller bioreactors (e.g., pond) may be designed and sized to adequately serve as “feeder” bioreactors to a larger bioreactor. Smaller bioreactors, in some embodiments, may be first inoculated and grown to high density at which point they may optimally seed a larger bioreactor in a manner that supports faster growth.

In some embodiments, a bioreactor system may comprise a monitoring system. A monitoring system may be configured to display and/or provide one or more user alerts regarding bioreactor condition(s) (e.g., nutrient concentrations, pH, dissolved oxygen levels, growth medium levels, microcrop distribution, flow rate, temperature) and/or adjust operating conditions (e.g., growth medium flow rate and/or timing and/or quantity of nutrient addition; “feeder” microcrop addition, oxygen or carbon dioxide addition), in some embodiments. Adjustments may be made continuously, semi-continuously, periodically, intermittently, as needed, at set or variable times, or any other interval. In some embodiments, adjustments may be selected to optimize growth rates and/or yield of the aquatic species. For example, a microcrop species may be grown in large-scale, open bioreactors with monitoring systems configured to adjust the introduction of materials (e.g., fresh or recycled water, recycled water and solids from process, fresh or recycled growth media) based on, for example, exposure to light, which may thereby regulate nutrient consumption rates.

A bioreactor system may comprise, in some embodiments, a single container in which the microcrop may be cultivated. In some embodiments, the bioreactor system may comprise multiple cultivation containers that may be connected, partially connected, or disconnected. A bioreactor (e.g., a pond), in some embodiments, may be an earthen basin with the embankments made of compacted dirt removed from the interior bottom of the bioreactor. According to some embodiments, the bioreactor may be an artificial container (e.g., metal, plastic, resin). A bioreactor system may comprise an open bioreactor, a closed bioreactor, a semi-open bioreactor, or any combination thereof. In some embodiments, a bioreactor system may be configured to divide the container(s) into channels or cells. A bioreactor system may be configured to permit a flow of growth medium, in some embodiments. A bioreactor system, in some embodiments, may include a propulsion system (e.g., paddle wheels, bubbling, submerged or surface water jets, submerged mixers) and/or a recirculation system. In some embodiments, a bioreactor system may be configured to adjust the flow rate of a growth medium (e.g., to redistribute nutrient concentrations or microcrop growth patterns).

In some embodiments a bioreactor system may be open (e.g., in a horizontal plane relative to the ground) of a bioreactor container (e.g., serpentine raceway) such that a growth medium contained within the bioreactor container and/or a microcrop growing on a top surface of the growth medium may be exposed to a wind initiating from an exterior of the bioreactor container. A bioreactor system, according to some embodiments, may be partially open (e.g., in a horizontal plane relative to the ground) with at least 90% or at least 80%, or at least 70%, or at least 60%, or at least 50%, or at least 40%, or at least 30%, or at least 20%, or at least 10% of the top surface of the contained culture media being open. A top surface may be open, according to some embodiments, where the surface is substantially free (e.g., free) of any covering or other barrier, where the surface is directly exposed to ambient weather conditions, where there is substantially no membrane, glass, cover or other barrier (whether or not such barrier has pores or apertures) between the surface and the atmosphere, and/or where ambient atmosphere is the only occupant of the space immediately and directly above the surface for a distance of at least about 1 meter above the surface.

A bioreactor system, in some embodiments, may monitor and adjust a thickness and distribution of a microcrop mat. For example, when a microcrop reaches a specified thickness or distribution a bioreactor system may initiate harvest procedures. In some embodiments, a minimum thickness of a microcrop mat may be maintained such that a desired evapotranspiration rate of a growth medium within a bioreactor system may be maintained. A minimum thickness of a microcrop may be maintained, in some embodiments, such that less sunlight is capable of penetrating a surface of a growth medium (i.e., reducing a growth potential of submerged aquatic species such as algae).

A bioreactor system may be any size suitable for the cultivation of a microcrop. For example, a bioreactor system, in some embodiments, may be between 0.5 ha and 50 ha.

A microcrop may be cultivated by any suitable method and is not limited to the method described herein. Various changes may be made in the method of cultivation of a microcrop without departing from the scope of the instant disclosure.

### Harvesting of a Microcrop

A microcrop may be harvested in whole or in part at any desired time(s) to form a biomass (e.g., a harvested biomass). For example, an aquatic microcrop may be harvested at one or more specific times, at regular or irregular intervals and/or continuously. Selection of harvest time(s) and/or intervals may be based on any number of considerations including: environmental conditions (e.g., precipitation, relative humidity, temperature range, average, low or high threshold and/or light intensity, wavelength range, duration of exposure, average solar radiation exposure in watts per square meter (W/m²), position of the sun on the horizon, cloud coverage); microcrop characteristics (e.g., mat thickness, mat distribution, maturation); and production flows and demands (e.g., to allow for a steady stream of biomass to a production facility such that there can be near constant to constant production of a microcrop product). For example, a microcrop may be harvested while having an average solar radiation exposure of about 1.0 W/m².

A harvest time, according to some embodiments, may be determined based on the time of day/night and/or ambient light conditions. In some embodiments, a harvest time may be selected based on the position of the sun in the sky (e.g., dusk, post-sunset). According to some embodiments, a microcrop may be harvested near or after sunset (i.e., when the upper limb of the sun disappears below the horizon) or within (includes the period both before and after) the following periods: 0.25 hours of sunset, or 0.5 hours of sunset, or 0.75 hours of sunset, or 1.0 hour of sunset, or 1.5 hours of sunset, or 2.0 hours of sunset, or 2.5 hours of sunset, or 3.0 hours of sunset. A harvest time, in some embodiments, may be after dark or with minimum light exposure (e.g., less than 5%). According to some embodiments, a harvest time may be when an ambient light level is less than 20%, or less than 15%, or less than 10%, or less than 5%, or less than 1%.

Harvesting an aquatic microcrop at a select time (e.g., after sunset) may promote the preservation of and/or enhance the quality of a harvested biomass (e.g., microcrop). In some embodiments, a system and/or method of the present disclosure may include transferring an aquatic microcrop from a growth area to a harvest canal at specific time points to maintain and increase protein levels prior to processing. In some embodiments, a microcrop may be transferred from a growth area to a harvest canal within the following periods: 1 hour before sunset, or 0.5 hours before sunset, or 0.25 hours before sunset, or at sunset, or after sunset, or 1 hour before sunrise, or 0.5 hours before sunrise, or 0.25 hours before sunrise, or at sunrise, or 0.25 hours after sunrise, or 0.5 hours after sunrise, or 1 hour after sunrise.

Harvesting a microcrop may be a manual or an automated process without deviating from the scope of the present disclosure. In some embodiments, a floating microcrop may be circulated around a bioreactor in order to transport a microcrop to a harvesting location (in addition to redistribution for wind mitigation and nutrient injection to obtain uniform nutrient distribution to a microcrop). In some embodiments, an automated skimmer system may collect a microcrop from a bioreactor system and transfer a harvested microcrop (e.g., via a pumping system) onto an inclined vibrating screen to separate a biomass from growth medium and debris. In some embodiments, a floating boom system may be manually or automatically positioned on the surface of the nutrient medium at a harvesting location to funnel a microcrop to a harvesting mechanism. Such a floating boom system may be repositioned after harvesting to allow normal, uninterrupted circulation of a microcrop. A microcrop, in some embodiments, may be harvested by vacuum skimming the microcrop from the bioreactor system through a stationary or mobile screen filter. According to some embodiments, a biomass slurry, including a harvested microcrop (e.g., Lemna) and a growth medium, may be conveyed to an inclined vibrating screen where a biomass (e.g., microcrop) may be separated from the growth medium.

In some embodiments, a system for harvesting a microcrop may include one or more biomass transfer apparatuses 204, as illustrated in FIG. 2. A biomass transfer apparatus 204 may facilitate the transfer of a biomass (e.g., a harvested microcrop, a harvested floating aquatic plant species) from one location to another. A biomass transfer apparatus 204 may include a conveyor belt or a system of flexible or hard pipes or shoots, according to some embodiments. In some embodiments, a biomass transfer apparatus 204 may include an inclined vibrating screen. Further, the transfer apparatus may incorporate measuring instruments and control systems such as load cells connected to programmable logic controllers and apparatus motors in order to measure and control rates of transfer and totalizing of harvested biomass. For example, a biomass transfer apparatus may control mat thickness on a harvest canal by transferring biomass at a fixed, optimal rate. A biomass transfer apparatus 204 may include a first end and a second end, where the biomass transfer apparatus 204 is configured to facilitate and/or allow the movement of a biomass from the first end to the second end. In some embodiments, a first end is in contact with an aquatic crop farm 202 (or a bioreactor 210) and a second end is in contact with a harvest canal 206. In some embodiments, a biomass transfer apparatus may be proximate to a harvest canal (i.e., not in direct contact) and may discharge a harvested biomass into a chute that then discharges into the harvest canal. A chute forms a bridge, allowing a farm operator an unimpeded access to a continuous corridor underneath the chute. In other embodiments, a first end of a biomass transfer apparatus is in contact with a harvest canal 206 and a second end is in contact with a location proximal to an aquatic crop farm 202 (e.g., a storage warehouse, a processing facility 208).

In some embodiments, a system of harvesting an aquatic crop 200 may include more than one biomass transfer apparatus 204, for example (1) one or more of the biomass transfer apparatuses 204 may be configured with a first end that is in contact with an aquatic crop farm 202 (or a bioreactor 210) and a second end that is in contact with a harvest canal 206, and (2) one or more of the biomass transfer apparatuses 204 may be configured with a first end that is in contact with a harvest canal 206 and a second end that is in contact with a location proximal to an aquatic crop farm 202 (e.g., a storage warehouse, a processing facility 208). In a specific embodiment, a system and method of harvesting an aquatic crop 200 comprises multiple biomass transfer apparatuses 204 with some of the biomass transfer apparatuses 204 configured to transfer biomass (e.g., a floating aquatic plant species) from a bioreactor 210 to a harvest canal 206 and other biomass transfer apparatuses 204 configured to transfer biomass from the harvest canal 206 to a processing center 208.

During harvesting, a separated growth medium may be recycled back into the bioreactor 210 system or to an additional storage container (e.g., container or pond), according to some embodiments. In some embodiments, at least about 40%, or at least about 50%, or at least about 60%, or at least about 70%, or at least about 80%, or at least about 90%, or at least about 95% of a growth medium (e.g., water) separated from a biomass may be recycled for further use in cultivating, harvesting, and/or processing an aquatic microcrop.

The present disclosure is not limited to those methods and systems described above for the harvesting of an aquatic microcrop. Any number of methods and systems relating to the harvesting and conveying of a microcrop may be used in conjunction with the present disclosure without deviating therefrom.

### Washing a Harvested Biomass

In some embodiments, harvesting and conveying a microcrop may include a wash procedure to remove excess growth medium, debris, contaminants, microorganisms, and/or toxins. Washing a harvested biomass may increase one or more desirable characteristics a microcrop product (e.g., a protein content) derived from the harvested biomass. A wash procedure may disinfect and/or disinfest a biomass, reducing or removing bacteria, fungi, viruses, insects, and any combination thereof, which are on or around the surfaces of the biomass. In some embodiments a wash procedure may be performed by exposing (e.g., submerging, spraying) at least one surface of a biomass to a wash solution (e.g., water, growth medium, antimicrobial solution). A wash solution, in some embodiments, may be combined with a biomass (e.g., first portion, second portion) to form a slurry.

According to some embodiments, washing a microcrop may be done while the microcrop is being transferred from a bioreactor 210 to a harvest canal 206 or may be done while transferring microcrop from the harvest canal 206 to be processed. A wash procedure may include elevating a microcrop out of a bioreactor 210, using an aerial sprayer to apply a wash solution to the microcrop, and then separating the microcrop from the applied wash solution with a vibratory separator to form a washed microcrop and a spent wash solution. The washed microcrop may be transferred from the vibratory separator to the harvest canal 206. In some embodiments, washing a microcrop may include spraying a wash solution (e.g., water) on a harvested biomass as it is conveyed on a biomass transfer apparatus.

In some embodiments, a wash solution may comprise any desired portion of recycled fluid. For example, a wash solution may comprise at least about 10% (v/v), at least about 20% (v/v), at least about 30% (v/v), at least about 40% (v/v), at least about 50% (v/v), at least about 60% (v/v), at least about 70% (v/v), at least about 80% (v/v), or at least about 90% (v/v) recycled from another stage of the process (e.g., recycled wash solution). In some embodiments, a wash solution may be an aqueous solution or solvent. A wash solution may contain one or more antimicrobials, de-infestation compounds, fatty acids, alcohols, chlorine, oxidizing compounds, and any combination thereof (e.g., ozonated water).

According to some embodiments, a wash solution may be applied at a high pressure. A wash solution may remain in contact with a biomass for at least about 1 second, or for at least about 5 seconds, or for at least about 10 seconds, or for at least about 20 seconds, or for at least about 30 seconds, or for at least about 1 minute, or for at least about 5 minutes. Some or all of a wash solution (e.g., water, growth medium, antimicrobial solution), in some embodiments, may be separated from a biomass (e.g., using an inclined screen or vibratory screen).

In some embodiments, some or all of a spent wash solution may be collected and reused/recycled (e.g., a recycled wash solution). At least about 40%, or at least about 50%, or at least about 60%, or at least about 70%, or at least about 80%, or at least about 90%, or at least about 95% of a wash solution (e.g., water) separated from the biomass may be recycled for future use as a recycled wash solution and/or as growth medium in a bioreactor system, according to some embodiments.

A wash solution, in some embodiments, may be adjusted to have any desired pH.

A wash solution may have a temperature below ambient temperature (e.g., below about 30° C.) at the time of use. Cooling a wash solution, and thereby the harvested biomass, may improve one or more desirable characteristics of a microcrop product (e.g., protein composition of a microcrop product). In some embodiments, a wash solution may have a temperature below about 35° C., or below about 30° C., or below about 25° C., or below about 20° C., or below about 15° C., or below about 10° C., or below about 5° C., where about includes plus or minus 2.5° C.

### Transporting a Harvested Biomass in a Harvest Canal

A harvest canal 206 may be positioned adjacent to at least one edge along the perimeter of an aquatic crop farm 202. For example, a harvest canal 206 may be separated from the aquatic crop farm 202 by only one wall or be minimally separated. In some embodiments, a harvest canal 206 location relative to one or more of an aquatic crop farm 202, a bioreactor 210, a harvest system, and a processing facility may contribute to decreased costs and technical complexities associated with transporting a microcrop from a growth area to a processing facility. Further, this layout allows harvesting to occur at multiple and opposite orientations of the growth systems (e.g., aquatic crop farm), an ability that is advantageous when harvesting an aquatic microcrop that can experience wind-driven piling (e.g., floating aquatic plants).

For example, as illustrated in FIG. 2, a bioreactor 210 may contain one or more receptacles having connected canals 206 (e.g., lazy-river configuration) and configured to allow a culture medium to flow in a continuous loop (i.e., recirculate continuously). This approach is particularly advantageous as it obviates the use of traditional crop transport technologies and equipment and the associated labor, operational and capital expenditures that typify large-scale agricultural harvest and transport operations; this is particularly true when the crop has a high-water content. A propulsion driven, re-circulating “lazy-river” style canal system is an effective means to move large amounts of biomass while limiting labor, energy and capital requirements. An illustrative embodiment uses a paddle wheel for propulsion of the biomass in a continuous loop canal configuration; providing a means of propelling the biomass to a location adjacent to a processing facility where it may be conveyed into a process building or, as needed, a circulating biomass may by-pass the facility in a continuous fashion and be introduced into a processing facility at a later time. In some embodiments, a system may include more than one interconnected or separate harvest canals with conveying mechanisms that may move a biomass between them to accommodate farming and processing systems. The harvest canal(s) may be adapted to irregular areas of land or farms built on non-uniform elevations using terracing.

A harvest canal 206 may be configured to contain a harvested biomass in a medium (e.g., first medium, second medium) and allow for transport of the harvested biomass from a first location (e.g., adjacent to a biomass transfer apparatus) to a second location (e.g., a processing facility). A medium includes water and any additives (e.g., nutrients) that may either promote desirable attributes (e.g., increase protein yield) in the harvested biomass; reduce non-desirable attributes (e.g., reduce oxalic acid content) in the harvested biomass, or a combination thereof, prior to processing. In some embodiments, nutrients may be added to a medium to produce a nutrified medium. For example, some nutrients include nitrogen, phosphorous, potassium, calcium, sulfur, magnesium, carbon, oxygen, iron, manganese, zinc, copper, nickel, or others. A harvest canal 206 may include a nutrient delivery system for delivering nutrients to a medium contained within the harvest canal 206. In some embodiments, a harvest canal 206 includes a monitoring system for monitoring a nutrient composition, a gas composition, a temperature, a velocity, a mat thickness, and a percentage of submerged harvested biomass of the medium and biomass contained within a harvest canal 206.

A medium contained within a harvest canal may be monitored to detect a nutrient composition of the medium, a gas composition of the medium, a temperature of the medium, a velocity of the medium, a thickness of a mat of the harvested biomass, and a percentage of the harvest biomass that is submerged in the medium. Any sensor known in the art may be used. In some embodiments, data provided by monitoring these medium parameters may be used to make changes to harvest canal operations in a feedback loop. For example, based on data provided by monitoring the medium, an adjustment of the propulsion mechanism may be made to alter one or more of the thickness of the mat of the harvested biomass and the percentage of the harvested biomass that is submerged.

According to some embodiments, a harvest canal may allow for the transport of a harvested biomass from an aquatic crop farm to a processing center. Additionally, in some embodiments, a harvest canal may provide a convenient means by which a harvested biomass can be simultaneously (1) transported from an aquatic crop farm to a processing center, (2) protected from thermal stress associated with exposure of the biomass to solar radiation, and (3) treated to enhance desirable properties.

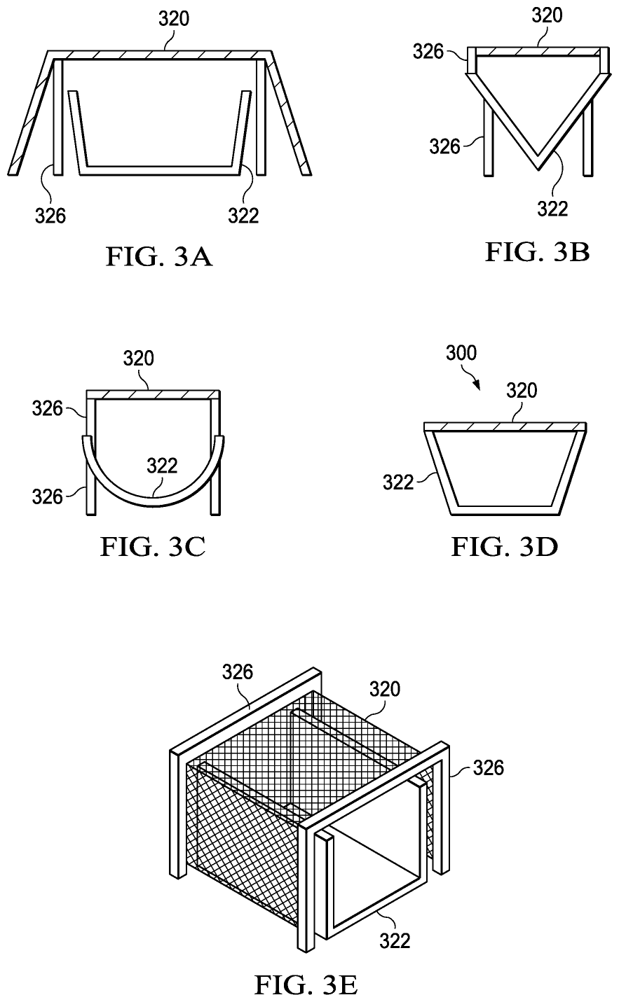

FIGS. 3A-E illustrate several example embodiments of a harvest canal 300. According to some embodiments, a harvest canal 300 may comprise a canopy 320 and a trough 322. A harvest canal 300, according to some embodiments, may comprise one or more supports 326. According to some embodiments, a canopy 320 may be removably secured over an open top of the trough 322 in a manner such that it generates a shaded interior (e.g., a shaded interior of the trough). In some embodiments, a harvest canal 300 may further comprise a propulsion mechanism (e.g., paddle wheel, bubbler, submerged or surface water jet). In some embodiments, the harvest canal 300 includes a canopy 320 secured over the open top surface of the trough 322 to generate a shaded interior having at least a 60% reduction in solar radiation compared to an external surface of the canopy. A canopy may generate a shaded interior having at least a 60% reduction in solar radiation, or a 70% reduction, or an 80% reduction, or a 90% reduction, or a 100% reduction in solar radiation compared to an external surface of the canopy.

### A Harvest Canal: Trough

As illustrated in FIG. 3A-E, a harvest canal 300 may include a trough 322. A trough, according to some embodiments, may comprise a container with a bottom surface, two or more peripheral walls, an interior, and a top surface that is open (e.g., an open top).

A top surface of a trough 322 may be open, according to some embodiments, where the surface is substantially free (e.g., free) of any covering or other barrier, where the surface is directly exposed to ambient weather conditions, where there is substantially no membrane, glass, cover or other barrier (whether or not such barrier has pores or apertures) between the surface and the atmosphere, and/or where ambient atmosphere is the only occupant of the space immediately and directly above the surface for a distance of at least about 1 meter above the surface. In some embodiments a trough 322 may be open (e.g., in a horizontal plane relative to the ground) such that a medium contained within the trough and/or a microcrop floating on a top surface of the medium may be exposed to a wind initiating from an exterior of the trough 322. A trough 322, according to some embodiments, may be partially open (e.g., in a horizontal plane relative to the ground) with at least 90% or at least 80%, or at least 70%, or at least 60%, or at least 50%, or at least 40% of the top surface being open.

As shown in FIGS. 3A and 3D, a trough 322 may include two or more peripheral walls joined through a bottom wall to generate an interior surface comprising a bottom surface and at least one interior surface such that the trough is capable of containing a volume of liquid medium (e.g., first medium) and a top surface that is open. In some embodiments, as shown in FIG. 3B, a trough 322 may include two peripheral walls that intersect each other to generate an interior surface having two interior surfaces. A trough 322, as shown in FIG. 3C, may have one or more curved peripheral walls that form an interior surface. FIG. 3E is an isometric view of a harvest canal 322 covered by a canopy 320 having two supports 326.

The dimensions (e.g., depth, width) of a trough may be adjusted based on the needs of the operation, for example, dimensions may vary depending on the aquatic microcrop under cultivation, the arrangement or number of growth areas (e.g., bioreactors) comprised in an aquatic crop farm, or the processing demand/limitations of the harvested floating aquatic plant species. By way of example, and not limitation, a trough 322 may be big enough to provide for enough space in the trough 322 so that 24-hour or greater production is enabled without compromising aquatic microcrop growth and processing.

A trough 322 may comprise any size (e.g., length) suitable for conveying a biomass from an aquatic crop farm to a processing facility. Accordingly, in some embodiments a trough 322 may be between 100 meters and 50,000 meters in length. A trough 322 may have a length of about 100 meters, or about 200 meters, or about 300 meters, or about 400 meters, or about 500 meters, or about 600 meters, or about 700 meters, or about 800 meters, or about 900 meters, or about 1,000 meters, where about includes plus or minus 50 meters. In some embodiments, a trough 322 may have a length of about 1,000 meters, or about 5,000 meters, or about 10,000 meters, or about 15,000 meters, or about 20,000 meters, or about 25,000 meters, or about 30,000 meters, or about 35,000 meters, or about 40,000 meters, or about 45,000 meters, or about 50,000 meters, where about includes plus or minus 500 meters.

A trough may be any depth suitable for retaining a volume of media suitable for allowing for the floating of a microcrop on and/or near its top surface. In some embodiments, a trough 322 may be from about 0.1 meters to about 5 meters deep. A trough 322 may have a depth of about 0.1 meters, or about 0.5 meters, or about 1.0 meters, or about 1.5 meters, or about 2.0 meters, or about 2.5 meters, or about 3.0 meters, or about 3.5 meters, or about 4.0 meters, or about 4.5 meters, or about 5.0 meters, where about includes plus or minus 0.25 meters.

A trough 322 may be configured to allow for the movement of a concentrated biomass from one location to another. For example, a trough 322 may allow for the movement of a concentrated biomass from an aquatic crop farm to a processing center. A harvested biomass may float on a surface of a first medium with a harvest canal forming a floating mat having a thickness. Overloading may further include having a thickness of a floating mat that is undesirable for maintaining key crop characteristics (e.g., protein content quality).

Permitting movement of a concentrated biomass from one location to another may prevent overloading of the harvest canal 300. Overloading may include having too much of the biomass submerged instead of floating. For example, overloading may include having greater than about 40% of the biomass submerged, or greater than about 50% of the biomass submerged, or greater than about 60% of the biomass submerged, or greater than about 70% of the biomass submerged, or greater than about 80% of the biomass submerged, or greater than about 90% of the biomass submerged, or greater than about 99% of the biomass submerged, where about includes plus or minus 5%.

A Harvest Canal: Propulsion Mechanism

A harvest canal 300 may include one or more propulsion mechanisms (e.g., paddle wheel, bubbler, submerged or surface water jet). A paddle wheel may include any form of waterwheel or impeller in which one or more paddles are set around the periphery of a wheel configured to rotate so that at least one paddle is submerged in the medium. A bubbler includes one or more tubes that are submerged in the medium and connected to a gas (e.g., air, CO2) tank. In some embodiments, a bubbler may push gas through the medium to propel the biomass through the medium. According to some embodiments, a submerged or surface water jet propels a fluid (e.g., water) through the medium to provide propulsion. The fluid includes the medium that may be derived from the harvest canal 300 and resupplied to the same or different harvest canal 300.

A propulsion mechanism may be in direct contact with a medium (e.g., first medium, second medium) in a trough 322 and may be configured to apply sufficient force to the medium to cause motion thereof. In embodiments where the medium contains a biomass (e.g., harvested floating aquatic plant species, concentrated biomass), the propulsion mechanism may impart a motion on the biomass (e.g., direct, indirect) in a manner such that the biomass may be transported from a first position to a second position.

In some embodiments, the propulsion mechanism may be configured to apply a continuous and/or variable force to the medium in a manner such that the resulting velocity (e.g., flow rate) of the medium may be modulated in a controlled manner. A propulsion mechanism, according to some embodiments, may be comprised in a propulsion system, which may additionally comprise motors (e.g., Variable Frequency Drives) which allow for modulation of the force produced by the propulsion mechanism and imparted on the medium and the resulting velocity of the medium and/or the biomass.

A resulting velocity of the medium and/or biomass may be controlled in a manner to maintain a substantially uniform distribution of a floating mat on the top surface of the medium. In some embodiments, the velocity includes a range of about 0.01 m/s to about 0.20 m/s, where about includes plus or minus 0.005 m/s. A velocity includes about 0.01 m/s, about 0.02 m/s, about 0.03 m/s, about 0.04 m/s, about 0.05 m/s, about 0.06 m/s, about 0.07 m/s, about 0.08 m/s, about 0.09 m/s, about 0.10 m/s, about 0.11 m/s, about 0.12 m/s, about 0.13 m/s, about 0.14 m/s, about 0.15 m/s, about 0.16 m/s, about 0.17 m/s, about 0.18 m/s, about 0.19 m/s, and about 0.20 m/s, where about includes plus or minus 0.005 m/s. A velocity may be maintained or adjusted as needed so that a uniform distribution of the floating mat on the top surface of the medium. In some embodiments, a velocity may be maintained such that a volume of biomass at a furthest point from a processing center will reach the processing center in a designated period of time (e.g., 24 hours).

During propulsion of a medium, ventilation of the medium may be maintained to remove hot air and/or humid air. In some embodiments, ventilation may be performed using a windscreen material that may vent autonomously. Additionally, a ventilation may include a forced ventilation including a fan-based system that may be solar powered. Removing hot air and/or humid air may reduce or substantially prevent mold growth within the medium.

A Harvest Canal: Canopy

A harvest canal 300 may include a canopy 320. A canopy may be capable of significantly reducing the exposure of a biomass in the harvest canal to light (e.g., full-spectrum, wavelength-specific light). Transferring a harvested microcrop from a growth system into a harvest canal 300 including a canopy may result in improved and/or stabilized protein levels. In some embodiments, a harvest canal including a canopy may be configured to protect a biomass from thermal stress, temperature shifts, solar radiation, wind velocity shifts, and/or animal intervention.

According to some embodiments, a canopy may be composed of a woven material. A woven material may include any material that can be woven to a mesh size capable of blocking solar radiation, according to some embodiments. In some embodiments, a woven material may include reflective, porous, and those constructed of a material with low thermal conductivity. According to some embodiments, a woven material may include a mesh size ranging from about 10 mesh to about 100 mesh. In some embodiments, a woven material may include a mesh size of about 10 mesh, or about 20 mesh, or about 30 mesh, or about 40 mesh, or about 50 mesh, or about 60 mesh, or about 70 mesh, or about 80 mesh, or about 90 mesh, or about 100 mesh, where about includes plus or minus 5 mesh. A woven material may be substantially solid and may include any kind of weave pattern. In some embodiments, a woven material includes one or more of a polyester, a polyethylene, an aramid, an acrylic, a nylon, a polyurethane, a spandex, an olefin, a lurex, a carbon fiber, a grass, a straw, a cotton, a rayon, a silk, and a wool. In some embodiments, a canopy is not a woven material, but is a substantially uniform material made of one or more of a polyester, a polyethylene, an aramid, an acrylic, a nylon, a polyurethane, a spandex, an olefin, a lurex, a carbon fiber, a grass, a straw, a cotton, a rayon, a silk, and a wool. In some embodiments, a canopy may include a multi-layered material. For example, a canopy may be made of one or more layers of any material, such as the above-described materials. For example, a canopy may include a high-strength polyethylene film, layer, a molten polyethylene bonding layer, a reinforced scrim, and a second high-strength polyethylene film. A canopy may have any thickness ranging for example, from about 0.1 mm to 1.0 mm. In some embodiments, a canopy may have a thickness of about 0.1 mm, or about 0.2 mm, or about 0.3 mm, or about 0.4 mm, or about 0.5 mm, or about 0.6 mm, or about 0.7 mm, or about 0.8 mm, or about 0.9 mm, or about 1.0 mm, where about includes plus or minus 0.05 mm.

In some embodiments, a canopy may include one or more light inhibitors that may reflect, refract, and absorb light including UV radiation. A light inhibitor may include organic and inorganic compounds including titanium dioxide, zinc dioxide, benzotriazole, a tetramethylpiperidine, a hindered amine light stabilizer (HALS), a cyanoacrylate, a benzotriazole, a triazine, and combinations thereof. A canopy may include one or more thermal stabilizers that prevent degradation of canopy components upon exposure to varying degrees of heat. A thermal stabilizer may include an organophosphate, a metal salt, a bisphenol type epoxy resin, a hydrolyzed polyvinyl alcohol, an organic acid salt, an aromatic alkyl benzoic acid, an organotin compound, and phenolic antioxidant, and combinations thereof.

A canopy may be capable of blocking solar radiation, for example in some embodiments a woven material may be capable of blocking at least 60%, or at least 65%, or at least 70%, or at least 75%, or at least 80%, or at least 85%, or at least 90%, or at least 95%, or at least 98%, or at least 99% of the solar radiation. In some embodiments, a canopy may be reflective. For example, a canopy may be capable of reflecting at least 40%, or at least 50%, or at least 60%, or at least 70%, or at least 80%, or at least 90%, or at least 95% of the ambient solar radiation.

In some embodiments, the canopy may be permeable to liquid and/or gases. In some embodiments a canopy may be permeable to water for example, to permit drainage of precipitation. The woven material may be permeable to gas (e.g., air) to promote breathability. A canopy 320 may allow for the interior of the trough 322 to be completely, partially, or substantially exposed to some ambient conditions (e.g., temperature, humidity, air flow, etc.) due to the woven material being able to be permeated by water and gas.

A canopy may be secured (e.g., permanently, removably) over an open top of a trough 322 to generate a shaded interior. A canopy 320 may be secured in any number of configurations without deviating from the present disclosure. For example, a canopy may be secured such that it is vaulted over an open trough or extended parallel to a top surface of a medium within the trough. A canopy may be secured, in some embodiments, such that there are one or more gaps between a top edge of the trough 322 and the canopy 320.

According to some embodiments, a canopy 320 may be secured in a manner such that the shaded interior of a harvest canal 300 is completely, partially, or substantially shaded from solar radiation (e.g., generating a shaded interior). In some embodiments, a shaded interior may have a level of solar radiation that is at most 100%, or at most 95%, or at most 90%, or at most 85%, or at most 80%, or at most 75%, or at most 70%, or at most 65%, or at most 60%, or at most 55%, or at most 50%, or at most 45%, or at most 40%, or at most 35%, or at most 25%, or at most 20%, or at most 15%, or at most 10%, or at most 5% as compared to the level of solar radiation on an exterior surface of the canopy 320.

In some embodiments, a shaded interior may have a decreased thermal temperature as compared to an exterior surface of the canopy 320. Such decreased thermal temperature may contribute to an increased crop quality (e.g., a protein quality). According to some embodiments, a shaded interior of a trough may have a thermal temperature that is at least about 5° C. less, or at least about 10° C. less, or at least about 15° C. less, or at least about 20° C. less, or at least about 25° C. less than a thermal temperature of an exterior surface of the canopy and/or an ambient temperature, where about includes plus or minus 2.5° C.

In some embodiments, a canopy 320 is any color, especially those which may aid in reflecting substantially all sunlight away from the harvest canal 300. For example, a canopy may be white or substantially white in color. A canopy 320 may be reflective or contain reflective components that aid in reflecting sunlight away from the harvest canal 300, and thus the medium and/or the biomass.

A Harvest Canal: Delivery and Monitoring Systems

According to some embodiments, a harvest canal may further comprise one or more delivery and/or monitoring systems (e.g., nutrient delivery system).

A delivery system may comprise a sprinkler or other type of delivery system, which may be positioned on the interior of the canopy, allowing for the delivery of nutrients, water, etc., by foliar application. In some embodiments, a nutrient delivery system may be incorporated into one or more supports 326 such that the nutrient delivery system is dispersed (e.g., regularly dispersed, irregularly dispersed) along the length of the harvest canal.

### Treating a Biomass in a Harvest Canal

According to some embodiments, an additive may be incorporated into a medium of a harvest canal such that it desirably affects the composition of the aquatic crop prior to processing. For example, inclusion of an additive may either promote desirable attributes (e.g., increase protein yield) in the aquatic crop; reduce non-desirable attributes (e.g., reduce oxalic acid content) in the aquatic crop, or a combination thereof, prior to processing. The harvest canal is uniquely suited to introducing additives in comparison to other parts of the protein production system since it generally has a limited volume of medium, which avoids having to use large volumes of the additives to generate the desired outcome

Some additives can be added to a medium that increase nutrient concentrations to a desirable level (e.g., ammonia). Additives can be added to the medium of a harvest canal in either a liquid, solid, or gas form using equipment known to the industry. For example, liquid additives may be added to a harvest canal through sprayers including boom sprayers, mist sprayers, three point hitch sprayers, truck-bed sprayers, hitch sprayers, spot sprayers, and backpack sprayers. Solids may be added using any mechanical scattering device including hand spreaders, screens (e.g., vibrating screen), broadcast spreaders, power spreaders, drop spreaders, motorized spreaders, and tow spreaders. In some embodiments, additives in a gaseous form may be added to the harvest canal by directly adding gases from a gas tank through a gas pressure regulator. In some embodiments, additives can be added in a continuous mode, a batch mode, and through multiple feed streams.

Some specific additives include compounds containing calcium, nitrogen, phosphorous, potassium, oxygen, and carbon dioxide. Calcium may be introduced through calcium sources including calcium carbonate, calcium oxalate, calcium oxide, calcium citrate, calcium carbide, calcium phosphate, calcium sulfate, calcium chloride, and combinations thereof. Nitrogen, phosphorous, and potassium may be added to a harvest canal as a solid, a liquid, or a gas. For example, nitrogen sources include ammonia (gas or liquid), ammonium sulfate (solid), or a variety or organic nitrogen sources. Potassium sources include potassium chloride and potassium carbonate. Oxygen and carbon dioxide may be added directly as a gas or by adding a liquid (e.g., water) having either a higher dissolved oxygen or dissolved carbon dioxide content.

According to some embodiments, an additive includes a pH value adjuster such as an acid (e.g., nitric, phosphoric, citric, acetic, and sulfuric acid) that lowers the pH value, a base (e.g., calcium carbonate) that raises the pH value, and a buffer (e.g., a mixture of a weak acid and its conjugate base) that maintains a pH value range. According to some embodiments, an additive may be added that changes (e.g., raises, lowers) or maintains a pH value of a medium contained within a harvest canal to below about 8.0, or below about 7.5, or below about 7.0, or below about 6.5, or below about 6.0, or below about 5.5, or below about 5.0, or below about 4.5, or below about 4.0, or below about 3.5, or below about 3.0, where about includes plus or minus 0.5. An additive may be added that changes or maintains a pH value of a medium to a range of: from about 3.0 to about 4.0, or from about 4.0 to about 5.0, or from about 5.0 to about 6.0, or from about 6.0 to about 7.0, or from about 7.0 to about 8.0, where about includes plus or minus 0.5.

In some embodiments, the effects of adding an additive to a harvest canal can increase or decrease multiple products developed by the crop as well as the yield of the crop itself. For example, providing an additive to the harvest canal may increase crop yield, increase protein yield, increase carbohydrate yield, decrease carbohydrate yield, increase oxalic acid yield, decrease oxalic acid yield, increase oxalate (e.g., calcium oxalate) yield, decrease oxalate yield, decrease production of exogenous aquatic organisms (e.g., bacteria), increase production of exogenous aquatic organisms, and combinations thereof.

As described above, an additive can increase or decrease multiple products developed by the crop. For example, adding nitrogen to a harvest canal may to produce an increased protein yield in a microcrop product.

According to some embodiments, the addition of additives may be ad hoc, and/or at specified time indicators, and/or in response to sensor readings from sensors monitoring the medium and/or biomass. In some embodiments, a harvest canal contains one or more sensors that may detect a concentration of one or more additives. Based on detected additive data, one or more additives may be provided or withheld from the medium contained within the harvest canal.

### Microcrop Product

Some embodiments relate to a process for production of a microcrop product (e.g., a whole tissue product, isolated protein product). In some embodiments, a microcrop product may be derived from a whole tissue of the harvested biomass, for example as a blanched tissue and/or a dried tissue. According to some embodiments, a microcrop product may be derived from a biomass of a harvested microcrop (e.g., Lemna). For example, a harvested biomass may be lysed and pressed to separate a juice portion from a solid portion, and a juice portion may be further treated (e.g., filtering, coagulating, microfiltering, ultrafiltering) to generate a protein product whereas a solid portion may be further treated (e.g., pressing, washing, drying) to generate a carbohydrate-rich microcrop product.

Microcrop Product: Protein Composition

In some embodiments, a microcrop product may have a protein concentration of at least about 35%, or at least about 40%, or at least about 45%, or at least about 50%, or at least about 60%, or at least about 65%, or at least about 70%, or at least about 75%, or at least about 80%, or at least about 85%, or at least about 90%, by dry mass basis (DMB). According to some embodiments, at least of portion of a protein composition of a microcrop product may comprise denatured or partially-denatured protein.

Microcrop Product: Protein Digestibility Corrected Amino Acid Score (PDCAAS) and Digestibility

According to some embodiments, a microcrop product may have a PDCAAS relative to a reference standard (e.g., casein) of at least 0.88, or at least 0.89, or at least 0.90, or at least 0.91, or at least 0.92, or at least 0.93, or at least 0.94, or at least 0.95. In some embodiments, a microcrop product may have a PDCAAS of between 0.88 and 0.94, or between 0.90 and 0.94, or between 0.92 and 0.94. PDCAAS may be evaluated, for example, by an animal (e.g., rat) model or by an in vitro enzyme digestion model. Calculating a PDCAAS value may be dependent upon a limiting amino acid. According to some embodiments, a PDCAAS value of a microcrop product may be limited by a histidine composition.

In some embodiments, a microcrop product may have a digestibility of at least 88%, or at least 90%, or at least 92%, or at least 94%, or at least 95%, or at least 96%, or at least 97%, or at least 98% in each case. Digestibility may be determined, for example, using a rat model (casein digestibility) or an in vitro digestibility method (e.g., Animal-Safe Accurate Protein Quality Score (ASAP-Quality Score) method, TIM model, dynamic gastric model (DGM)).

Microcrop Product: Oxalic Acid Content

According to some embodiments, a microcrop product may have a reduced oxalic acid (H₂C₂O₄ or HOOCCOOH) content. In some embodiments, a microcrop product may have an oxalic acid content of lower than about 1.5%, or lower than about 1.4%, or lower than about 1.3%, or lower than about 1.2%, or lower than about 1.1%, or lower than about 1.0%, or lower than about 0.9%, or lower than about 0.8%, or lower than about 0.75%, or lower than about 0.7%, or lower than about 0.65%, or lower than about 0.6%, lower than about 0.55%, lower than about 0.5%, or lower than about 0.45%, or lower than about 0.4%, or lower than about 0.35%, or lower than about 0.3%, or lower than about 0.25%, or lower than about 0.2%, or lower than about 0.15%, or lower than about 0.1%, or lower than about 0.05%, or lower than about 0.04%, or lower than about 0.03%, or lower 0.02% by DMB. A microcrop product, in some embodiments may have an oxalic acid content of from about 0.02% to about 0.6%, from about 0.02% to about 0.5%, or from about 0.02% to about 0.4%, or from about 0.02% to about 0.3%, or from about 0.02% to about 0.2%, or from about 0.02% to about 0.15%, or from about 0.02% to about 0.1% by DMB. In some embodiments, a microcrop product may have an oxalic acid content of no more than 0.1%. According to some embodiments, a microcrop product may have an oxalic acid content of no more than 0.05% DMB.

### Continuous Production

The present disclosure further relates to methods of continuously feeding a processing facility with a volume of biomass to generate a microcrop product. Such continuous feeding is desirable as it allows for increased efficiency, productivity, and profitability.

According to some embodiments, a disclosed method may employ a harvest canal having a raceway design. For example, a disclosed harvest canal may form an infinity loop and not include any dead ends. By having a raceway design, a biomass and medium contained within a harvest canal may continuously float throughout the harvest canal at a given velocity (e.g., ranging from about 0.1 m/s to about 0.20 m/s) until it is transferred to a processing facility (in whole or in part). The velocity of the continuously floating medium and/or biomass may be controlled using various methods to maintain a substantially uniform distribution of a floating mat on the top surface of the medium. A first method of controlling the velocity of the continuously floating medium and/or biomass is to remove biomass from the harvest canal once it gets too thick and begins to form a slurry. A second method of controlling the velocity of the continuously floating medium and/or biomass is to activate a propulsion mechanism to increase the propulsion of the contents of the harvest canal around the loop. For example, the rotational speed of a paddle wheel may be increased to mechanically propel the contents of the harvest canal around the loop. In some embodiments, a raceway design may include any known raceway components including a number of loops, straights, feed conveyors, overflow regulators, conveyor belts, braces, braces with cable loops, and bridges.

In some embodiments, a harvest canal may include a first position and a second position. After a bioreactor system has cultivated a microcrop, the microcrop can be harvested to generate a biomass that may be transferred from the bioreactor system to the first position of the harvest canal. The second location may serve as a point to transfer biomass from the harvest canal to a processing facility.

A method of continuously producing a biomass may include cultivating a microcrop in a bioreactor system, harvesting the microcrop to generate a biomass, conveying the biomass to a first position in a harvest canal to form a conveyed biomass. The harvest canal may be positioned adjacent to an outer perimeter of the bioreactor system and may run substantially parallel to at least a portion of the bioreactor system. A method may include propelling the conveyed biomass around the harvest canal to form a propelled biomass. The propelled biomass may travel at a velocity such that the biomass maintains a substantially uniform distribution of a floating mat on the top surface of a medium that may already be contained within the harvest canal or may have been transferred from the bioreactor system. In some embodiments, a biomass may be propelled in a harvest canal at a velocity suitable to maintain at least 60% of the biomass floating on the surface (i.e., not submerged in the water column).

In some embodiments, a method may include transferring at least a portion of the propelled biomass from the harvest canal to a processing facility to form a transferred biomass. The propelled biomass may be transferred from the second point of the harvest canal to the processing facility. As described above, the propelled biomass may be transferred from the second end of the harvest canal to the processing facility before the propelled biomass gets thick enough to begin overloading (e.g., where greater than about 40% of the biomass is submerged). A propelled biomass may be transferred from the second end of the harvest canal to the processing facility when greater than about 40% of the biomass is submerged, or greater than about 50% of the biomass is submerged, or greater than about 60% of the biomass submerged, or greater than about 70% of the biomass submerged, or greater than about 80% of the biomass submerged, or greater than about 90% of the biomass submerged, or greater than about 99%, where about includes plus or minus 5%. Transferring may be performed manually or automatically. For example, a sensor may detect when a threshold value of the biomass is submerged and may then transfer a portion of the biomass from the harvest canal to the processing facility to prevent overloading. Additionally, transferring may be performed manually without any detected data on the percentage of biomass submerged.

According to some embodiments, to maximize loading of a harvest canal, the rate of conveyed biomass formation may be substantially similar to the rate of transferred biomass formation so that both components have a ratio of about 1:1 on a volume basis. For example, the ratio of conveyed biomass to transferred biomass may range from about 1:10 to about 10:1 on a volume basis. The ratio of conveyed biomass to transferred biomass may be about 1:10, or about 1:9, or about 1:8, or about 1:7, or about 1:6, or about 1:5, or about 1:4, or about 1:3, or about 1:2, or about 1:1, or about 10:1, or about 9:1, or about 8:1, or about 7:1, or about 6:1, or about 5:1, or about 4:1, or about 3:1, or about 2:1 on a volume basis, where about includes plus or minus 0.5.

Various changes may be made in the shape, size, number, separation characteristic, and/or arrangement of parts without departing from the scope of the instant disclosure. Each disclosed method and method step may be performed in association with any other disclosed method or method step and in any order according to some embodiments. Where the verb “may” appears, it is intended to convey an optional and/or permissive condition, but its use is not intended to suggest any lack of operability unless otherwise indicated. Various changes may be made in methods of preparing and using a composition, device, and/or system of the disclosure without departing from the scope of the instant disclosure. Where desired, some embodiments of the disclosure may be practiced to the exclusion of other embodiments.

Also, where ranges have been provided, the disclosed endpoints may be treated as exact and/or approximations as desired or demanded by the particular embodiment. Where the endpoints are approximate, the degree of flexibility may vary in proportion to the order of magnitude of the range. For example, on one hand, a range endpoint of about 50 in the context of a range of about 5 to about 50 may include 50.5, but not 52.5 or 55 and, on the other hand, a range endpoint of about 50 in the context of a range of about 0.5 to about 50 may include 55, but not 60 or 75. In some embodiments, the degree of flexibility may simply be a specific percentage of the disclosed end point (e.g., ±1% where tight control of end point values is desirable, ±10% where end point values are flexible and/or vary according to other parameters). In addition, it may be desirable, in some embodiments, to mix and match range endpoints. Also, in some embodiments, each figure disclosed (e.g., in one or more of the examples, tables, and/or drawings) may form the basis of a range (e.g., depicted value+/−about 10%, depicted value+/− about 50%, depicted value+/− about 100%) and/or a range endpoint. With respect to the former, a value of 50 depicted in an example, table, and/or drawing may form the basis of a range of, for example, about 45 to about 55, about 25 to about 100, and/or about 0 to about 100. Unless otherwise designated within this disclosure, percentages as applied to concentrations are percentages on a dry mass basis (DMB).

These equivalents and alternatives along with obvious changes and modifications are intended to be included within the scope of the present disclosure. Accordingly, the foregoing disclosure is intended to be illustrative, but not limiting, of the scope of the disclosure as illustrated by the appended claims.

The title, abstract, background, and headings are provided in compliance with regulations and/or for the convenience of the reader. They include no admissions as to the scope and content of prior art and no limitations applicable to all disclosed embodiments.

### EXAMPLES

Some specific example embodiments of the disclosure may be illustrated by one or more of the examples provided herein.

### Example 1: Changes in Protein Levels in an Aquatic Plant Crop Over 12 Hours Uncovered and Covered with Different Liners

To examine the changes in protein levels in aquatic plant crop of both uncovered and covered canals, four canal configurations were prepared from harvested Lemna samples. As a control, a first canal did not have any covering. Three covered canals configurations were prepared with a first having a black liner that blocks 100% of sunlight exposure, a second having a black liner that blocks 90% of sunlight exposure, and a third having a white liner that blocks 100% of sunlight exposure. The liners used to cover the canals were constructed from polyvinyl chloride frames that held the liner material. The frames were placed over the raceways with light blocking material overlapping the sides of the raceways to prevent light from entering the sides.

To prepare the Lemna samples, Lemna was cultivated in a raceway patterned cultivation system as mats of floating microcrop. A mini raceway (4.5 m²) and a full size raceway (13,770 m²) were used. A harvesting procedure was initiated when the average solar radiation was at 1 W/m² on the morning after the microcrop mats reached a designated thickness (See Table 2 below). The microcrop mats were harvested from mini-raceways that were manually harvested with nets. The excess growth media was removed via small laundry spinner. The harvested biomass was then deposited into a series of each of the four harvest canals each having different degrees of covering. Each harvest canal had a propulsion mechanism including a paddlewheel propelling the contents at a velocity from 7-12 meters/min (about 0.1 to about 0.2 m/s). The harvested biomass was maintained in each harvest canal for a period of 12 hours before being removed from the harvest canal and processed. Over the 12-hour period, the protein levels of the aquatic plant crop in each test canal were tested and compared.

TABLE 2
Average Solar Radiation

| Time | W/m² |
|---|---|
| 12 AM-5 AM | 0 |
| 6 AM | 1.0 |
| 7 AM | 48.3 |
| 8 AM | 201.3 |
| 9 AM | 369.8 |
| 10 AM | 523.8 |
| 11 AM | 642.0 |
| 12 PM | 701.1 |
| 1 PM | 737.1 |
| 2 PM | 638.5 |
| 3 PM | 468.7 |
| 4 PM | 379.9 |
| 5 PM | 295.5 |
| 6 PM | 174.8 |
| 7 PM | 70.3 |
| 8 PM | 7.2 |
| 9 PM-11 PM | 0 |

The control having no covering began with 42% protein (dry mass basis), dropped to 40% protein content over a 6-hour period, and further dropped to 36% protein content at twelve-hour point. In contrast, the harvest canal covered with the black liner that blocked 100% of sunlight exposure began at 43% protein, increased to 44% protein over a 6-hour period, and maintained protein levels to end at 43% protein at 12 hours. Similarly, the sample having the white liner that blocked 100% of sunlight exposure began at 44% protein and maintained 44% protein through the 6 and 12-hour period. The harvest canal covered black liner that blocked 90% of sunlight exposure performed similarly to the other covered harvest canals in that is began with 43% protein, increased to 45% protein at 6 hours, and ended at 42% protein at 12 hours.

Therefore, the more the samples that were covered maintained protein levels throughout the 12-hour period, whereas the samples not covered showed a marked decline in protein levels. Additionally, the greater the coverage, the greater the protein levels are maintained as is shown when comparing the samples covered 90% from sunlight to the samples cover 100% by sunlight. Additionally, samples covered by a white liner seem to be the most protected.

### Example 2: Changes in Protein Levels in an Aquatic Plant Crop Over 12 Hours Uncovered and Covered with Different Liners

A second examination of the four-harvest canal covering configurations shown in Example 1 was performed that provided similar results.

The control having no covering began with 41% protein (dry mass basis), dropped to 38% protein over a 6-hour period, and further dropped to 35% protein content at twelve hours. The harvest canal covered with the 100% block black liner began at 40% protein, increased to 42% protein over a 6-hour period, and ended with slightly higher protein levels to end at 41% protein at 12 hours. The 100% block white liner began at 40% protein and maintained 40% protein through the 6 and 12-hour period. The harvest canal covered 90% began with 41% protein, maintained a 41% protein at 6 hours, and ended at 40% protein at 12 hours. This data replicates and confirms the data shown in Example 1 that the greater the coverage from sunlight, the greater the protein levels are maintained.

### Example 3: Diurnal Changes in Protein Levels in an Aquatic Plant Crop in Two Independent Growth Systems

Protein cycling was observed by monitoring a protein content of a Lemna crop over a 50 hour period. A Lemna crop was grown in two separate bioreactor systems using methods outlined in Examples 1 and 2. Samples were harvested from each bioreactor system at two hour intervals beginning at 7 am and extending for a 50 hour period. The protein content of the harvested Lemna samples was evaluated and the remainder of each sample was transferred to a harvest canal that was covered with a light blocking canopy. Lemna samples were prepared as described for Examples 1 and 2 above.

The results showed that Lemna biomass harvested in low light conditions (e.g., early morning, night) had the highest protein levels, while samples harvested during high light conditions (e.g., mid-day) had decreased protein levels. Specifically, the protein levels exhibited a diurnal trend having the highest levels pre-dawn with levels dropping over the course of the day and rising again after sunset.

In a specific example, the two samples (one from each bioreactor system) taken at 7 am had 43% and 44% protein content respectively. By 4 pm that same day the protein content for samples taken from the bioreactor systems had dropped to 36% and 38% respectively. By 8 am on day 2 of the experiment, the protein levels in the bioreactor crops had risen to 43% for both samples. Followed by a drop consistent with the first day to 37% and 38% by 4 pm on the second day. The samples taken from both bioreactors at 8 am on the third day had again risen to 44% protein content. This illustrates that harvest time impacts protein content, which in combination with the Experiments 1 and 2 allows for optimization of harvesting and maintaining protein content and quality in a Lemna product.

We claim:

1. A harvest canal system for conveying a harvested biomass comprising a floating aquatic plant, the system comprising:
a trough comprising at least two peripheral walls joined to generate a bottom surface and an open top surface and configured to contain the harvested biomass in a volume of a first medium;
a canopy secured over the open top surface of the trough to generate a shaded interior having at least a 60% reduction in solar radiation compared to an external surface of the canopy; and
a propulsion mechanism configured to impart a motion on the first medium such that the harvested aquatic biomass is transported from a first position to a second position.

2. The harvest canal system according to claim 1, wherein the canopy comprises a woven material comprising one or more of a polyester, a polyethylene, an aramid, an acrylic, a nylon, a polyurethane, a spandex, an olefin, a lurex, a carbon fiber, a grass, a straw, a cotton, a rayon, a silk, and a wool.

3. The harvest canal system according to claim 1, wherein the propulsion mechanism comprises one or more of a paddle wheel, a bubbler, a submerged, and a surface water jet.

4. The harvest canal system according to claim 1, wherein the shaded interior generated by the canopy has at least an 80% reduction in solar radiation compared to the external surface of the canopy.

5. The harvest canal system according to claim 1, wherein the canopy comprises at least one of a light inhibitor and a thermal stabilizer.

6. The harvest canal system according to claim 1, wherein the harvest canal system further comprises one or more of:
a nutrient delivery system;
a monitor configured to measure at least one of a nutrient composition, a gas composition, and a temperature of the first medium;
a monitor configured to measure a velocity of the first medium;
a monitor configured to measure a thickness of a mat of the harvested biomass; and
a monitor configured to measure a percentage of the harvested biomass that is submerged.

7. The harvest canal system according to claim 1, wherein the harvest canal is positioned adjacent to an outer perimeter of a bioreactor system and forms an infinity loop.

8. A method for conveying a harvested biomass comprising a floating aquatic plant species from a harvest apparatus to a second location, the method comprising:
conveying the harvested biomass to a first position of a harvest canal, the harvest canal comprising:
a trough comprising at least two peripheral walls joined to generate a bottom surface and an open top surface and configured to contain the harvested biomass in a volume of a first medium;
a canopy secured over the open top surface of the trough to generate a shaded interior having at least a 60% reduction in solar radiation compared to an external surface of the canopy; and
a propulsion mechanism configured to impart a motion on the first medium such that the harvested biomass is transported from the first position to the second position.
activating the propulsion mechanism to impart the motion on the first medium and propel the harvested biomass from the first position to the second position.

9. The method according to claim 8, wherein the method further comprises washing the harvested biomass before the harvested biomass is conveyed to the first position of the harvest canal.

10. The method according to claim 8, wherein activating the propulsion mechanism imparts a velocity on the first medium in a range from about 0.1 m/s to about 0.20 m/s.

11. The method according to claim 8, further comprising monitoring at least one of:
a nutrient composition of the first medium;
a gas composition of the first medium;
a temperature of the first medium;
a velocity of the first medium;
a thickness of a mat of the harvested biomass; and
a percentage of the harvested biomass that is submerged.

12. The method according to claim 11 further comprising adjusting the propulsion mechanism to alter at least one of:
the thickness of the mat of the harvested biomass; and
the percentage of the harvested biomass that is submerged.

13. The method according to claim 8 further comprising adjusting a composition of the first medium by adding one or more of a calcium, a nitrogen, a phosphorous, a potassium, an oxygen, a carbon dioxide, an acid, a base, and a buffer.

14. The method of continuously supplying a harvested biomass comprising a floating aquatic plant species to a processing facility, the method comprising:
(a) cultivating a microcrop comprising the floating aquatic plant species in a bioreactor system;
(b) harvesting the microcrop to generate the harvested biomass;
(c) conveying the harvested biomass to a first position of a harvest canal to form a conveyed biomass, wherein the harvest canal comprises:
(i) a trough comprising at least two peripheral walls joined to generate a bottom surface and an open top surface and configured to contain the conveyed biomass in a volume of a medium, and
(ii) a propulsion mechanism configured to impart a motion on the first medium such that the harvested biomass is transported from the first position to the second position within the harvest canal;
wherein the harvest canal is positioned adjacent to an outer perimeter of bioreactor system and forms an infinity loop;
(b) activating the propulsion mechanism to impart the motion on the first medium and propel the harvested biomass from the first position to the second position; and
(c) transferring at least a portion of the propelled biomass from the second position of the harvest canal to a processing facility to form a transferred biomass.

15. The method according to claim 14, wherein the harvest canal further comprises a canopy secured over the open top surface of the trough to generate a shaded interior having at least a 60% reduction in solar radiation compared to an external surface of the canopy.

16. The method according to claim 14, wherein a ratio of the conveyed biomass to the transferred biomass ranges from about 1:10 to about 10:1 on a volume basis.

17. The method according to claim 14, wherein the motion imparted on the first medium results in a velocity of the first medium ranging from about 0.1 m/s to about 0.20 m/s.

18. The method according to claim 14, further comprising monitoring at least one of:
a nutrient composition of the first medium;
a gas composition of the first medium;
a temperature of the first medium;
a velocity of the first medium;
a thickness of a mat of the harvested biomass; and
a percentage of the harvested biomass that is submerged in the first medium.

19. The method according to claim 18 further comprising triggering the transferring of the propelled biomass from the second position of the harvest canal to the processing facility when greater than about 40% of the harvested biomass is submerged in the first medium.

20. The method according to claim 18 further comprising adjusting the propulsion mechanism to alter at least one of:
the thickness of the mat of the harvested biomass; and
the percentage of the harvested biomass that is submerged.
